(19) United States
(12) Patent Application Publication
(10) Pub. No.: US 2013/0014872 A1
(43) Pub. Date: Jan. 17, 2013

(54) TYRE TREAD INCLUDING AN IMPROVED NOISE REDUCTION DEVICE

(71) Applicants: Nicolas Dautrey, Chamalieres (FR); Nanae Shimanaka, Ota (JP)

(72) Inventors: Nicolas Dautrey, Chamalieres (FR); Nanae Shimanaka, Ota (JP)

(73) Assignees: MICHELIN RECHERCHE ET TECHNIQUE S.A., Granges-Paccot (CH); COMPAGNIE GENERALE DES ETABLISSEMENTS MICHELIN, Clermont-Ferrand (FR)

(21) Appl. No.: 13/522,791

(22) PCT Filed: Jan. 18, 2011
(86) PCT No.: PCT/EP2011/050587

§ 371 Date: Oct. 2, 2012

(30) Foreign Application Priority Data
Jan. 19, 2010 (FR) 1050313

(51) Int. Cl. B60C 11/117

(52) U.S. Cl. 152/209.18

(57) ABSTRACT

Tread for a tyre, made of a rubber material with a shore A hardness of at least 65, this tread being provided with at least one groove of circumferential overall direction, this tread comprising a plurality of closure membranes formed in at least one groove of circumferential overall direction, each closure membrane, of a mean thickness of at most 2 mm, closing a groove over at least 50% of the cross section of the said groove, each closure membrane being able to flex as liquid flows, the closure membranes furthermore being formed of a material with a shore A hardness of at most 62, this shore A hardness being lower than the shore A hardness of the tread.

### FIELD OF THE INVENTION

The present invention relates to a tread for a tyre, this tread being provided with a flexible device that reduces the noise caused by the resonance of the air flowing along the grooves of circumferential overall direction.

### PRIOR ART

It is known that when a tyre is running along a road surface and a patch of that tyre comes into contact with that road surface air is made to circulate in a pipe formed by a groove of circumferential overall direction and the road surface itself, this pipe being open at both ends. The air in this pipe forms a column of air in vibration, the resonant frequency of which is dependent on the length between the two ends of the pipe and therefore on the length of groove in contact with the road surface.

This resonance of the air in the grooves has the effect, in a vehicle fitted with these tyres, of generating noise inside the vehicle and noise outside the vehicle.

These inside and outside noises usually correspond to a frequency of or around 1 kHz which is a frequency to which the human ear is particularly sensitive. In order to reduce such resonance noise, it is known practice for a plurality of relatively thin closure membranes made of a rubber material to be fitted in each groove of circumferential or generally circumferential direction, each closure membrane occupying the entire cross section of the groove or at the very least the majority of this cross section. Each closure membrane may extend from the bottom of the groove or be fixed to at least one of the walls that delimit the said groove. Relatively thin means that each closure membrane is able to flex in order to open up the cross section of the groove under a flow of liquid notably when driving in rainy weather.

Thanks to these closure membranes, the length of the air column in each circumferential groove is reduced by comparison with the total length of the groove in the contact patch, and this results in a change in resonant frequency. The frequency is shifted towards resonant frequency values to which the human ear is less sensitive.

Of course, in order to maintain the water clearing function when driving on a wet road surface, it is necessary for this membrane to be able to flex suitably under the action of the water pressure and thus open up the cross section of the groove. Various solutions of this type for reducing the resonance of the air column vibrating in the grooves have been proposed.

Such an approach is, for example, described in patent document EP0908330 B1, and notably in FIG. 4a of that patent.

However, it has been found that, for certain tyres that have a tread made of a rubber material with a very high shore A hardness, the use of this solution of the prior art leads to a number of disadvantages.

One of these disadvantages is connected with the fact that, in order to obtain a membrane that is very flexible, so as to maintain good water flow properties in rainy weather, the thickness of this membrane had to be reduced given the very high shore A hardness of the material of which the tread was made.

Another disadvantage, which also combines with the previous disadvantage, is connected with the fact that moulding this very thin membrane becomes more difficult. Specifically, the filling with the raw material of the hollows formed for this purpose in the mould in order to mould each membrane is difficult if not completely impossible. What actually happens is that the material becomes blocked and vulcanizes even before it has completely filled the space provided for moulding this membrane, this vulcanizing being a consequence of the very small thickness of the membrane. As a result, with a material of high shore A hardness, the closure membrane obtained only partially blocks the cross section of the groove within which this closure membrane is formed. This results in a moulding defect which leads to a resonance noise which is not completely reduced when the tyre is new.

### DEFINITIONS

A groove is a volume in a space delimited by opposing walls of material, these walls of material being connected by a groove bottom. A groove has a width corresponding to the mean distance separating the two opposing walls of material and a depth which substantially measures the height of the said walls. The opposing walls of a groove do not come into contact with one another under the normal conditions of use of a tyre.

Tyre contact patch: when a tyre is running under its nominal mounting rim, pressure and loading conditions of use (as defined in standards such as the E.T.R.T.O. the J.A.T.M.A. or the T.R.A. standards), a contact area (or contact patch) representing contact between the tyre and the road surface is formed.

The shore A hardness of the rubber compositions after curing is measured in accordance with the 1997 standard ASTM D2240.

In the present application, a material is said to have a high shore A hardness if its shore A hardness is at least equal to 65.

The objective of the invention is to provide a solution to a tread for a tyre, this tread being produced from a material of high shore A hardness and in which the grooves of circumferential overall direction are provided with closure membranes that reduce the resonance noise while at the same time maintaining good water clearing performance in rainy weather, these closure membranes being able to be moulded without presenting the disadvantages of the closure membranes of the prior art.

### SUMMARY OF THE INVENTION

In order to fulfil this objective, the invention proposes a tread for a tyre, this tread being produced from a material of high shore A hardness, i.e. one that has a hardness of at least 65, this tread having at least one groove of circumferential overall direction having a depth D and a width W, this groove being delimited by two opposing tread parts joined together by a groove bottom. Also formed in at least one groove of circumferential overall direction are a plurality of closure membranes intended to close each circumferential groove over at least 50% of the cross section of the groove, these closure membranes having a thickness of at most 2 mm and being able to flex as liquid flows. This tread is such that the closure membranes are formed of a material having a shore A hardness of at most 62, this shore A hardness being lower than the shore A hardness of the tread.

A method for moulding such a structure has been described in a patent application filed in 2009 and relating to a removable device for moulding a flexible wall in a groove of a tyre tread. This application (published on 23 Dec. 2010 under the number

WO 2010/146180) describes a mould of the type comprising circumferentially arranged lining elements intended to form the tread pattern of the tread of the tyre, these lining elements comprising beads intended to form the impression of the grooves in the tread pattern. This mould further comprises one or more inserts each comprising a body secured to the lining and a head. These inserts have a slit or one or more reservations made in one or other of the faces of the insert, these slits or reservations being intended to contribute to moulding a thin flexible membrane which is articulated to at least one of the walls of the channel. These inserts are arranged in at least one of the beads, so that the said slit or the said reservation is positioned substantially perpendicular to the longitudinal direction of the channel.

Advantageously, the difference between the shore A hardnesses of the material of which the tread is made and of the material of which the closure membranes are formed is at least 10 points.

Advantageously, each closure membrane closes a groove over at least 90% of the transverse cross section thereof.

This combination of materials of specific shore A hardnesses means that thin membranes (at most 2 mm thick) that occupy the entire desired cross section of the groove and which after vulcanizing can easily flex under the effect of the pressure of a liquid flowing along the grooves can be obtained by moulding.

For preference, the closure membranes are connected to the bottom of the groove, which means that they are integrated into the material that at least partially forms the bottom of the groove. Advantageously, the material of which the bottom of the groove is made, i.e. the material that extends over a depth of at least 1 mm from the bottom of the groove, is different from the material of which the tread is made and has a shore A hardness lower than the shore A hardness of the material of the tread and at most equal to 62.

What is meant by a material that at least partly forms the bottom of a groove is a material which may extend in the circumferential direction over the entire circumferential length of this groove or alternatively just on each side of each closure membrane over a length shorter than the distance separating two closure membranes within the said groove.

This material in the groove bottom may be identical to the material of which the closure membranes are made or alternatively may have a shore A hardness that is somewhere between the hardness of the material of which the tread is made and that of the material of which the closure membranes are made so as to avoid any concentration of load where the closure membranes meet the bottom of the grooves.

The thickness of each closure membrane is at least equal to 0.2 mm and at most equal to 2.0 mm for a tyre fitted to a passenger vehicle. For preference, each groove is closed at least over 50% of its transverse cross section and more preferably still, over at least 70%.

Other features and advantages of the invention will emerge from the description given hereinafter with reference to the attached drawings which, by way of non limiting examples, show some embodiments of the subject matter of the invention.

### BRIEF DESCRIPTION OF THE DRAWINGS

In these drawings:

FIG. 1 shows, in plan view, part of a tread according to the invention, this part forming the contact patch in contact with a road surface;

FIG. 2 shows a local cross section through the tread of FIG. 1, this cross section being along the line II-II;

FIG. 3 shows the same cross section as FIG. 2, in a configuration of running on a road surface that is covered with water;

FIG. 4 shows a partial plan view of an alternative form of tread according to the invention, whereby the material that forms the groove bottom one each side of each closure membrane is different from the material of the tread;

FIG. 5 shows a cross section on the line V-V of FIG. 4;

FIG. 6 shows a cross section of another alternative form of tread according to the invention;

FIG. 7 shows another alternative form of the invention.

### DETAILED DESCRIPTION OF THE FIGURES

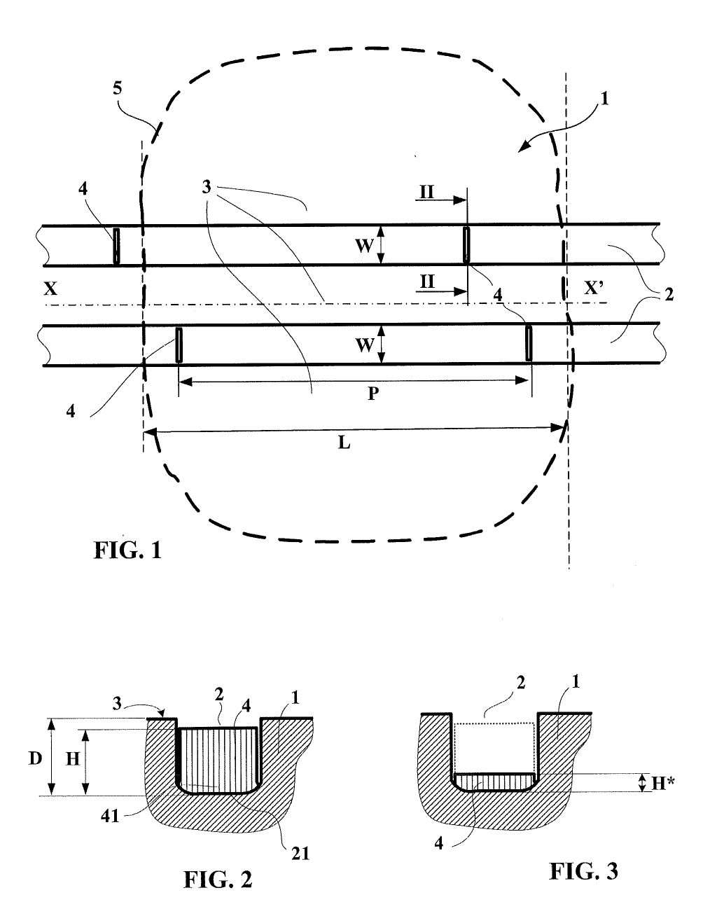

FIG. 1 shows a plan view of a tread 1 with which a tyre of size 225/55 R 16 is equipped. The tread 1 shown is provided with two main straight grooves 2 of circumferential direction (this direction is indicated in the figure by the axis XX′). The circumferential grooves have a mean width W of 10 mm and a depth D (visible in FIG. 2) of 8 mm. This tread comprises a plurality of elements the external faces of which form a tread surface 3 intended to come into contact with a road surface during the running.

Superimposed in dotted lines on this FIG. 1 is the outline 5 of the contact patch in contact with the road surface when this tyre is subjected to its nominal conditions of use namely an inflation pressure of 2.5 bar and a load of 677 daN. In this example, the mean length L of the contact patch in contact with the road surface is equal to 143 mm.

An air column forms in each main groove 2 passing through contact with the road surface during running and this begins to vibrate and goes into resonance at a frequency that is a function of the length of the air column. In order to modify the resonant frequency of each air column this length is reduced. This is why each circumferential groove 2 has a plurality of closure membranes 4 to close each groove. The mean distance P between the closure membranes is less than the length L of the patch so that there is always at least one closure membrane present in the contact patch for each groove. In the instance depicted, each closure membrane 4 extends from the bottom of the groove 2 and over a height of 7.5 mm. The thickness of these closure membranes 4 is, in this instance, equal to 0.8 mm.

In this instance, the groove closure membranes 4 are formed of a material that has a shore A hardness of 35. The material of which the tread is formed has a shore A hardness of 67.

FIG. 2 shows a local cross section through the tread of FIG. 1, this cross section being along the line II-II.

This FIG. 2 shows that the closure membranes are in the unflexed position and close the cross section of the grooves 2 over at least 80% of the cross section of the said grooves. This FIG. 2 shows that the closure membrane 4 has a base 41 connected to the bottom 21 of the groove 2 up to a height H which, in this particular instance, is equal to 93% of the depth D of the groove 2. Moreover, this closure membrane 4 occupies practically the entire width of the groove 2, although it does leave an appropriate clearance to allow ease of flexing of such a closure membrane 4 when a flow of liquid is flowing along this groove.

In a configuration of running over a dry road surface, the flow of air alone is not enough to cause the closure membranes 4 to flex and the latter therefore close the grooves in order to reduce the lengths of air column in vibration, as shown in FIG. 2.

FIG. 3 shows a cross section taken at the same point as the cross section used in FIG. 2 when the tyre is running over a road surface covered with water. This FIG. 3 shows that the closure membrane 4 has flexed when in the contact patch, thus allowing the water to flow. Thanks to the greater elasticity and greater flexibility of the material of which the closure membranes 4 are made in comparison with the basic material of the tread, it is possible for the closure membranes to flex enough to allow the water to flow and thus limit the risks of aquaplaning. Once flexed, each membrane adopts a height H* measured from the bottom 21 of the groove, this height H* being all the smaller the smaller the thickness of the closure membrane (in this particular instance this thickness is equal to 0.8 mm). The lower the shore A hardness of the material of which the closure membrane is formed, the shorter this height H* is also.

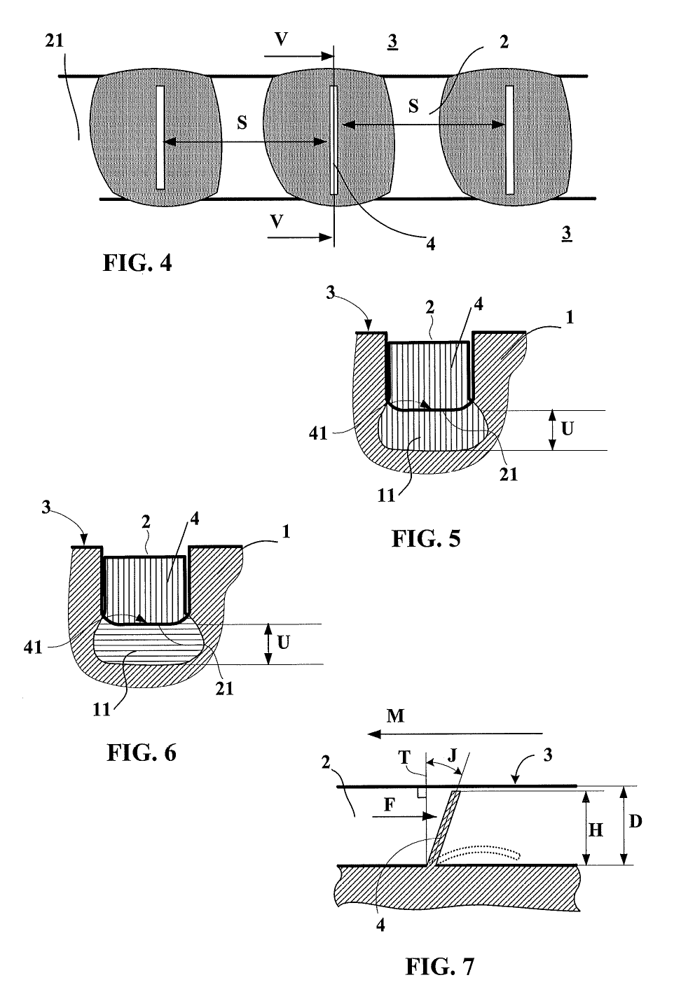

FIG. 4 shows a partial plan view of an alternative form of tread according to the invention, whereby the material of which the groove bottom 21 is formed on either side of each closure membrane 4 is different from the material of which the tread is made.

In this alternative form, each closure membrane 4 comprises a base 41 (visible in FIG. 5) which is connected to the bottom 21 of the grooves 2. FIG. 4 shows that circumferentially on either side of the closure membrane 4, the bottom 41 of the groove is made of a material which is identical to the material of which the closure membrane 4 is made. The benefit of such a structure is that it makes the membranes easier to mould, providing the certainty that the base of the membranes will be correctly formed of a material of low shore A hardness. Another advantage lies in better flexibility of the membranes about their base.

FIG. 5 shows a cross section on the line V-V of FIG. 4. This FIG. 5 shows that in the thickness of the tread from the bottom 41 of the groove 4, the material of which the closure membrane 4 is made is extended by one and the same material 11 over a thickness (U) of at least 1 mm, this thickness being measured with respect to the bottom 21 of the groove.

In another alternative form shown in FIG. 6, the tread 1 is made of a material of shore A hardness equal to 70, this material forming the running surface 3 of this tread. Each closure membrane is made of a material of shore A hardness equal to 50 and is connected by its base 41 to the bottom 21 of the groove 2. In order to provide the connection between each closure membrane 4 and the tread 1, the part 11 situated below the groove bottom 41 and of thickness U is made of a material of shore A hardness that is somewhere between the hardnesses of the materials of the tread and of the closure membranes. In this particular instance, the shore A hardness of the groove bottom 41 is equal to 60.

FIG. 7 shows another alternative form of the invention, whereby all the closure membranes 4 are made of a material having a shore A hardness at most equal to the shore A hardness of the material of which the tread is made and furthermore at least 10 point lower than the shore A hardness of the material of which the tread is made. Furthermore, to make it even easier for the closure membranes 4 to flex under the effect of a flow of liquid, these closure membranes 4 are inclined by an angle J with respect to a perpendicular T to the tread surface 3. The direction of the closure membranes is such that each closure membrane in its initial state—which means as it leaves the manufacturing mould—lies in the quadrant in which this closure membrane 4 is going to flex under the effect of a flow of liquid, this flow being in a direction F opposite to the direction M of travel of the tyre. This configuration does of course impose a preferred direction of running on the tyre provided with said tread, it being possible for this preferred direction of running to be indicated by a visible device affixed to the tyre. This angle of inclination J, measured with respect to a perpendicular T to the tread surface of the tread, is preferably chosen to be at most equal to 30 degrees.

The invention is not restricted to the examples described and depicted and various modifications can be made thereto without departing from its scope. In particular, these same closure membranes can be used to close grooves that are directed transversally or obliquely.

1. A tread for a tyre, this tread being made of a rubber material with a shore A hardness of at least 65, this tread being provided with at least one groove of circumferential overall direction having a width W and a depth D, this groove being delimited by two opposing tread parts joined together by a groove bottom, this tread comprising a plurality of closure membranes formed in at least one groove of circumferential overall direction, each closure membrane closing a groove over at least 50% of the cross section of the said groove, each closure membrane, of a mean thickness of at most 2 mm, being able to flex as liquid flows, this tread being wherein the closure membranes are formed of a material with a shore A hardness of at most 62, this shore A hardness being lower than the shore A hardness of the tread.

2. A tread according to claim 1, wherein the difference between the shore A hardness of the material of which the tread is formed and the shore A hardness of the material of which the closure membranes are formed is at least 10 points.

3. A tread according to claim 1, wherein the closure membranes extend in each groove from the bottom of the said groove.

4. A tread according to claim 3, wherein each closure membrane closes a groove over at least 90% of the transverse cross section of the said groove.

5. A tread according to claim 3, wherein the material of which the bottom of the groove is made, i.e. the material that extends over a depth of at least 1 mm from the bottom of the groove, is different from the material of which the tread is made and has a shore A hardness lower than the shore A hardness of the material of the tread and of at most equal to 62.

6. A tread according to claim 5, wherein the material in the groove bottom has a shore A hardness that is somewhere between the hardness of the material of which the tread is made and the shore A hardness of the material of which the closure membranes are made.

7. A tread according to claim 1, wherein the closure membranes are all inclined by the same angle, this angle, measured with respect to a perpendicular to the running surface of the tread, being at most equal to 30 degrees.

8. A tread according to claim 2, wherein the closure membranes extend in each groove from the bottom of the said groove.

9. A tread according to claim 4, wherein the material of which the bottom of the groove is made, i.e. the material that extends over a depth of at least 1 mm from the bottom of the groove, is different from the material of which the tread is made and has a shore A hardness lower than the shore A hardness of the material of the tread and of at most equal to 62.

10. A tread according to claim 2, wherein the closure membranes are all inclined by the same angle, this angle, measured with respect to a perpendicular to the running surface of the tread, being at most equal to 30 degrees.

11. A tread according to claim 3, wherein the closure membranes are all inclined by the same angle, this angle, measured with respect to a perpendicular to the running surface of the tread, being at most equal to 30 degrees.

12. A tread according to claim 4, wherein the closure membranes are all inclined by the same angle, this angle, measured with respect to a perpendicular to the running surface of the tread, being at most equal to 30 degrees.

13. A tread according to claim 5, wherein the closure membranes are all inclined by the same angle, this angle, measured with respect to a perpendicular to the running surface of the tread, being at most equal to 30 degrees.

14. A tread according to claim 6, wherein the closure membranes are all inclined by the same angle, this angle, measured with respect to a perpendicular to the running surface of the tread, being at most equal to 30 degrees.
